(19) United States
(12) Patent Application Publication
(10) Pub. No.: US 2018/0174019 A1
(43) Pub. Date: Jun. 21, 2018

(54) ARTIFICIAL INTELLIGENCE ANALYSIS SERVICE

(71) Applicant: NewsRx, LLC, Atlanta, GA (US)

(72) Inventors: Charles W. Henderson, Atlanta, GA (US); Kalani K. Rosell, New Haven, CT (US)

(73) Assignee: NewsRx, LLC

(21) Appl. No.: 15/379,701

(22) Filed: Dec. 15, 2016

(51) Int. Cl. G06N 3/00; G06N 99/00

(52) U.S. Cl. CPC G06N 3/006; G06N 99/005

(57) ABSTRACT

Technologies are described herein for providing an artificial intelligence analysis service. According to some examples, content received from an Content provider is analyzed to generate guidance instructions. The guidance instructions are transmitted to other Content providers. One or more nodes may provide feedback to the AI analysis service, wherein the feedback may be integrated with the guidance instructions.

### BACKGROUND

Content provided by artificial intelligence sources is becoming more prevalent. From reports generated by financial information to news created from current events, content generated by an artificial intelligent source is increasingly being relied on by various businesses to provide content.

It is with respect to these and other considerations that the disclosure made herein is presented.

### SUMMARY

Technologies are described herein for an artificial intelligence analysis service. Generally described, the artificial intelligence (“AI”) analysis service receives artificial intelligence content from one or more artificial intelligence content sources, analyzes the AI content, and provides input to various entities. In one example, the AI analysis service establishes a learning portal for AI content. The AI analysis service receives AI content from an AI source, receives feedback as to one or more issues with the AI content, and then provides the feedback to one or more second AI sources to train the one or more second AI sources.

In some examples, the AI analysis service receives AI content from one or more AI sources, analyzes the content to determine patterns associated with AI content, and then analyzes content provided by one or more second AI sources to identify AI content.

As used herein, “artificial intelligence” content is content constructed, written, or otherwise created by an artificial intelligence source. “Artificial intelligence” is broadly defined to be a computing source configured to operate fully or partially autonomously to generate content. It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an artificial intelligence analysis service.

FIG. 2 is a screen diagram illustration guidance instructions.

FIG. 3 is a screen diagram of a nodal system that can be used in conjunction with an AI analysis service.

FIG. 4 is a flow diagram showing a routine illustrating aspects of a mechanism disclosed herein for providing an AI analysis service.

FIG. 5 is a computer architecture diagram illustrating an illustrative computer hardware and software architecture for a computing system capable of implementing the technologies presented herein.

### DETAILED DESCRIPTION

The following detailed description is directed to technologies for an artificial intelligence analysis service. Content providers, such as news agencies or news aggregators, are increasingly reliant on content provided by artificial intelligence sources. Further, computer programs are increasingly written by other programs for various reasons including, but not limited to, increasing efficiency, decreasing coding costs, and the like.

Artificial intelligence sources can be more cost effective and timely than human sources. However, the use of artificial intelligence can create issues. For example, readers of content may believe that the content was written by a human, not knowing that the content was generated by an artificial intelligence source. In another example, the content may be identified as coming from a human source, but may have been generated in part (or in whole) by an artificial intelligence source.

Presently, there are numerous organizations attempting to create artificial intelligence content. Each source typically uses one or more proprietary algorithms to create content. The content is generated, with each content provider trying to create better or different types of content to differentiate themselves from the other content. The content providers typically act independently from each other, attempting to protect proprietary algorithms for generating AI content.

The presently disclosed subject matter provides technologies that, among other uses, analyzes content provided by one Content provider and provides feedback to other Content providers. The feedback can be used by the other content providers to help develop their AI content capabilities. Thus, the various Content providers can learn from other Content providers.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, aspects of technologies for an AI analysis service will be presented.

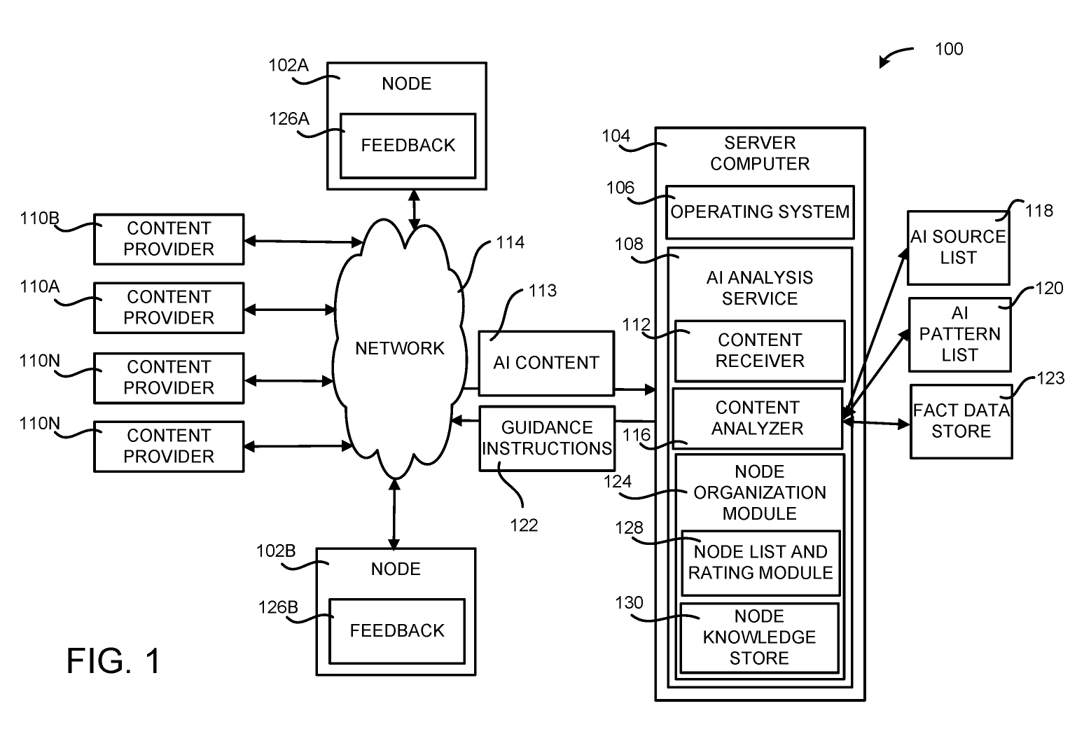

Referring now to FIG. 1, aspects of an artificial intelligence system 100 to provide an AI analysis service is described. The AI system 100 shown in FIG. 1 includes nodes 102A and 102B (hereinafter collectively referred to as “nodes 102” and individually as “node 102A” and “node 102B) 102 and a server computer 104. According to various configurations, the functionality of the nodes 102 or the server computer 104 can be provided by a personal computer (“PC”) such as a desktop, tablet, or laptop computer system. In some other configurations, the functionality of the nodes 102 or the server computer 104 can be provided by other types of computing systems including, but not limited to, a handheld computer, a netbook computer, an embedded computer system, a mobile telephone, a smart phone, or another computing device.

Various aspects of the nodes 102 or server computer 104 are illustrated and described below. Although the functionality of the nodes 102 or the server computer 104 is primarily described herein as being provided by a tablet or slate computing device, a smartphone, or a PC having a touch-sensitive display, because the functionality described herein with respect to the nodes 102 or server computer 104 can be provided by additional and/or alternative devices, it should be understood that these examples are illustrative, and should not be construed as being limiting in any way.

The server computer 104 is configured to execute an operating system 106. The operating system 106 is a computer program for controlling the operation of the server computer 104. The operating system 106 is executed to execute an AI analysis service 108. In some examples, the AI analysis service 108 is designed to provide communication or share information between one or more content providers 110, such as content providers 110A-110N (hereinafter referred to generally as “the content providers 110” and individually as “the content provider 110A,” “the content provider 110B,” and so forth).

The content providers 110 can include Internet websites or a source of data, a source of video, a source of text, a source of software code, a source of audio, and the like. The presently disclosed subject matter is not limited to any particular type of content provider 110. It should also be understood that various aspects of the presently disclosed subject matter can be performed wholly or partially on other devices, such as another server computer (not shown).

The AI analysis service 108 is used to provide various functionality or services to one or more of the content providers 110. In one example, the AI analysis service 108 generates and provides guidance instructions to one or more of the content providers 110 based on AI content generated by other content providers 110. The AI analysis service 108 invokes a content receiver 112 to receive AI content 113 from the content providers 110 through network 114. The content receiver 112 can be a data store configured to receive and store the AI content 113. Upon receiving the content, the content is provided to a content analyzer 116.

The content analyzer 116 analyzes the AI content 113 received from one or more of the content providers 110. The content analyzer 116 analyzes the AI content 113 based on various factors. In some examples, the content analyzer 116 can analyze the AI content 113 against one or more standards. For example, the content analyzer 116 can analyze the AI content 113 to determine the detectability of the content as being provided by or written by an artificial intelligence source.

Technologies for determining whether content is provided by or written by an artificial intelligence source can vary. For example, one or more of the content providers 110 may have been previously identified as artificial intelligence sources. An artificial intelligence (AI) source list 118 can be accessible to the content analyzer 116. The AI source list 118 can include a listing of one or more content providers that have been previously identified as artificial intelligence sources of content. Thus, the content analyzer 116 can compare the identification of the content provider 110 against the content providers listed in the AI source list 118. If the content provider 110 is included in the list, the content analyzer 116 can provide an output to the AI analysis service 108 indicating the finding.

In another example, the fact data store 123 may have access to an AI pattern list 120. The AI pattern list 120 includes words or phrases, as well as other information, that indicates the presence of artificial intelligence content. For example, content generated by an artificial intelligence source may not be provided through a particular content provider 110, but rather, may be released through various content providers 110.

In this example, the AI pattern list 120 may have stored therein one or more patterns that can be used to identify an artificial intelligence source. By analyzing various forms of content known to be from artificial intelligence sources, the AI pattern list 120 may have stored therein one or more patterns that are found in the analyzed content. For example, the content analyzer 116 may have analyzed a million news articles from one or more known artificial intelligence sources. After the analysis, the content analyzer 116 may have determined a pattern found in several of the analyzed content.

For example, the content analyzer 116 may have determined that the analyzed AI content 113 uses sentences in a “subject-verb-object” order in over fifty percent of the sentences contained within the AI content 113. Thus, a pattern stored in the AI pattern list 120 may be the order of the sentences at a particular rate within the AI content 113. Another example may be the use of a particular adjective across content from a particular source. For example, an artificial intelligence content provider may be programmed to use “powerful” in relation to a homerun in an article about a baseball game. The AI pattern list 120 may have stored therein that pattern as being a pattern associated with artificial intelligence content. These and other examples of patterns are included within the scope of the presently disclosed subject matter.

Upon analyzing the AI content, the content analyzer generates a guidance instruction 122. The guidance instruction 122 includes information relating to the analysis of the AI content 113 by the content analyzer 116. For example, the guidance instructions 122 can include a numerical summation of words or phrases that the content analyzer 116 deems to be greater than a desirable or predetermined amount, indicating that the AI content 113 was indeed generated by an AI source rather than a human. The guidance instructions 122 can also provide the AI content 113 analyzed. The following is an example of a guidance instruction 122:

Content Analyzed: Legal Proceedings Summary

Identified AI Content Portion: 80% subject-verb-object form sentences

AI identified phrase found in 12 other content analyzes: The court is proceeding as normal.

The guidance instruction 122 is provided to one or more of the content providers 110. The content providers 110 that receive the guidance instruction 122 can use the guidance instruction 122 to further refine their AI content. For example, the content providers 110 can modify their algorithms to exclude or reduce the use of the phrase, “The court is proceeding as normal,” as that phrase was found in other content identified as AI. Thus, by generating and providing the guidance instruction 122, the AI analysis service 108 can create a learning environment for the content providers 110.

The guidance instruction 122 can also be used to provide factual support for the AI content 113. For example, the content analyzer 116 can parse the AI content to determine one or more facts contained in the AI content 113. The facts can be checked using a fact data store 123. The fact data store 123 can be one or more data stores having data stored therein. For example, the fact data store 123 can be a population data store that can be accessed to check population facts asserted in the AI content 113. If the facts are unsubstantiated or incorrect, the content analyzer 116 can modify the guidance instructions 122 to indicate that the AI content 113 may be incorrect.

To further refine the guidance instructions 122, or to separately provide additional guidance to one or more of the content providers 110, the AI analysis service 108 can execute a node organization module 124. The node organization module 124 coordinates communication with one or more nodes, such as the nodes 102A and node 102B.

The nodes 102 can provide feedback 126A and 126B to the AI analysis service 108. The nodes 102 can receive the AI content 113 and provide input as to various aspects of the AI content 113. For example, the feedback 126A can be a qualitative or subjective assessment of the AI content 113. The feedback 126A can be a rating from 1-10 of how the AI content 113 appears to be written by a human, with 10 being most similar to human-like writing and 1 being most similar to artificial intelligence content. The feedback 126 is received by the AI analysis service 108 and provided as guidance to the content providers 110. The presently disclosed subject matter is not limited to any particular type of feedback 126.

The node organization module 124 stores a listing of the nodes 102 in a node list and rating module 128. The node list and rating module 128 is used by the node organization module 124 to track activity of the nodes 102. For example, the node list and rating module 128 can analyze the feedback 126 provided by the nodes 102 and determine which feedback 126 is erroneous, purposefully incorrect, or in line with other feedback 126 provided by other nodes 102. In that manner, the node organization module 124 can remove nodes 102 for various reasons, such as an appearance that a node 102 is purposefully providing incorrect feedback 126.

In some examples, a content provider, such as the content provider 110A, can provide AI content 113 to be analyzed before being released to the public. The AI analysis service 108 can be used to refine the AI content 113 using the guidance instructions 122 provided by the AI analysis service.

In some examples, the guidance instructions 122 provided by the AI analysis service 108 is input regarding the progression of a particular content provider 110. For example, the AI analysis service 108 can compare guidance instructions 122 of past AI content 113 provided by a particular content provider 110. If the guidance instructions 122 are similar, noting little to no progression of the AI content 113 to reduce issues with the AI content 113, the AI analysis service 108 can note the areas in which the AI content 113 continually lack, such as consistently overusing a particular sentence structure, overuse of certain words, and the like.

The node organization module 124 can also maintain a node knowledge store 130. The node knowledge store 130 is updated with the analyzed AI content 113, the feedback 126, information from the node list and rating module 128, and/or the guidance instructions 122. In some examples, the node knowledge store 130 is updated as AI content 113 is analyzed, thus maintaining a constantly updating record of information.

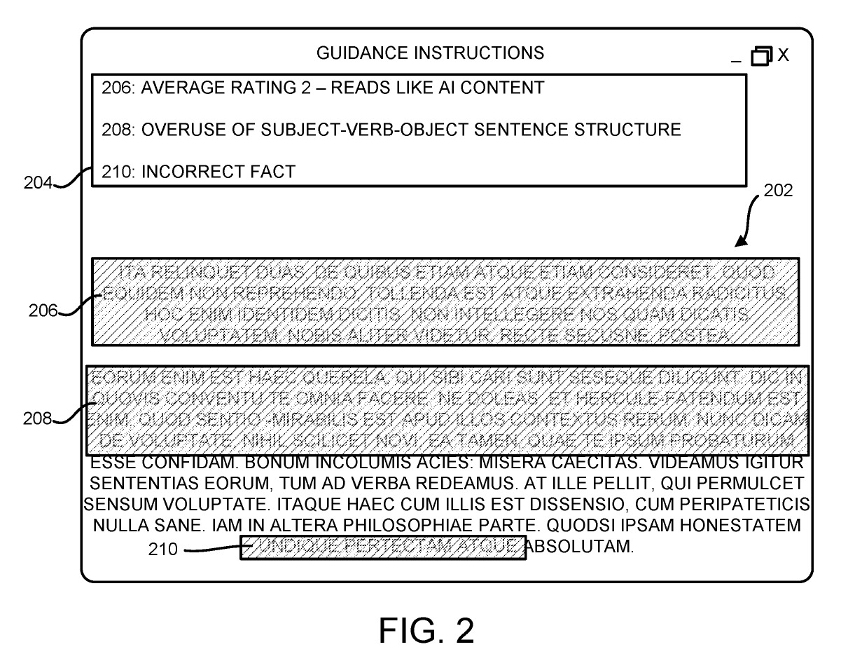

FIG. 2 is a screen diagram illustrating guidance instructions. In FIG. 2, AI content 202 is analyzed by an AI analysis service, such as the AI analysis service 108 of FIG. 1. As a result of the analysis, guidance instructions 204 are provided. The guidance instructions 204 can include input from a content analyzer, such as the content analyzer 116 of FIG. 1, one or more nodes, such as the nodes 102 of FIG. 1, and/or other sources such as the fact data store 123 of FIG. 1.

The guidance instructions 204 include guidance 206, which indicates that the AI content 202 received feedback that AI content 202 indicated by guidance 206 reads like artificial intelligence content. In some examples, human input can be used to determine if the AI content 202 reads like AI content. A human can be tasked with reading the AI content 202, with the human providing an input. Guidance 208 indicates that the AI content 202 overuses a particular sentence structure. Guidance 210 indicates that a fact is incorrect. The guidance instructions 204 can be provided to one or more of the content providers 110.

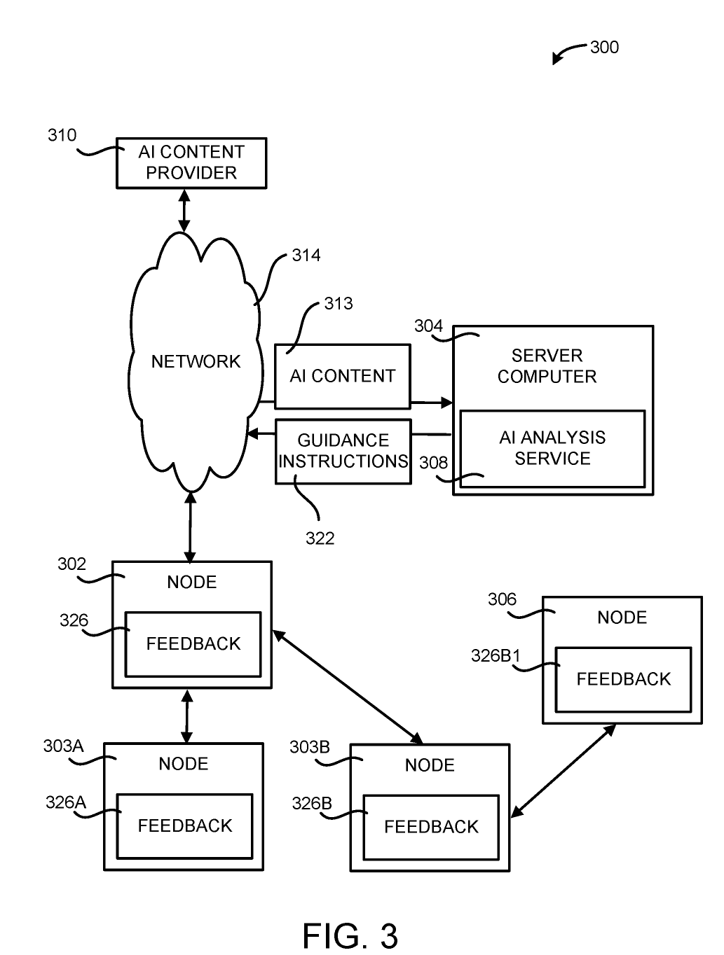

FIG. 3 is a screen diagram of a nodal system 300 that can be used in conjunction with an AI analysis service 308. In some examples, one or more nodes can act together to provide feedback prior to the introduction of the feedback to an AI analysis service. For example, a first node can be programmed with a first capability and a second node can be programmed with a second capability. The AI content to be analyzed can be accessed by both the first node and the second node. The output of the first node and the second node can be analyzed by a third node to provide a final feedback to an AI analysis service.

For example, in FIG. 3, a server computer 304 is executing an AI analysis service 308. The AI analysis service 308 receives AI content 313 from one or more content providers, such as the content provider 310, through the network 314. The AI analysis service 308 analyzes the AI content 313 and provides guidance instructions 322.

To assist the AI analysis service 308 in generating the guidance instructions 322, the AI analysis service 308 can use input from a network of nodes 302, 303A, 303B, and 306. In some examples, the nodes 302, 303A, 303B, and 306 have specific capabilities for providing feedback 326. In one example, the node 302 collects and organizes feedback 326A from node 303A, feedback 326B from node 303B, and feedback 326B1 from node 306.

In some examples, the node 302 breaks down the AI content 313 according to the capabilities of the nodes 303A and 303B. For example, the node 303A can be programmed to analyze the AI content 313 to determine if the AI content 313 is highly structured (e.g. consistently uses subject-verb-object sentence formation), showing that the AI content 313 looks like content from an AI source, or, more random, showing that the content may be written by a human.

The node 303B analyzes the AI content 313 to determine if the AI content 313 can be used in a malicious manner. For example, the AI content 313 may include text, source code, metadata, or other information that, when received and/or executed by a destination computer, may cause undesirable actions at the destination computer (not shown). For example, the AI content 313 can be source code for a program. The AI content 313 can be analyzed to determine if the AI content 313 includes code that has been found in other AI content that is malicious and is designed to cause undesirable effects on a destination computer. The node 306 analyzes the AI content 313 identified by the node 303B as possibly comprising malicious code. In that manner, the node 306 can analyze the code while the node 303B searches for additional code that potentially includes malicious code.

The node 302 receives the feedback 326A from the node 303A, the feedback 326B from the node 303B, and the feedback 326B1 from the node 306 and provides the feedback 326. The AI analysis service 308 receives the feedback 326 from the node 302 and generates the guidance instructions 322. It should be noted that the organization of the nodes 302, 303A, 303B, and 306 shown in FIG. 3 is merely an example, as the nodes 302, 303A, 303B, and 306 may be communicatively connected to each other in a different manner, additional nodes may be used, fewer nodes may be used, and the like. The presently disclosed subject matter is not limited to any particular nodal configuration.

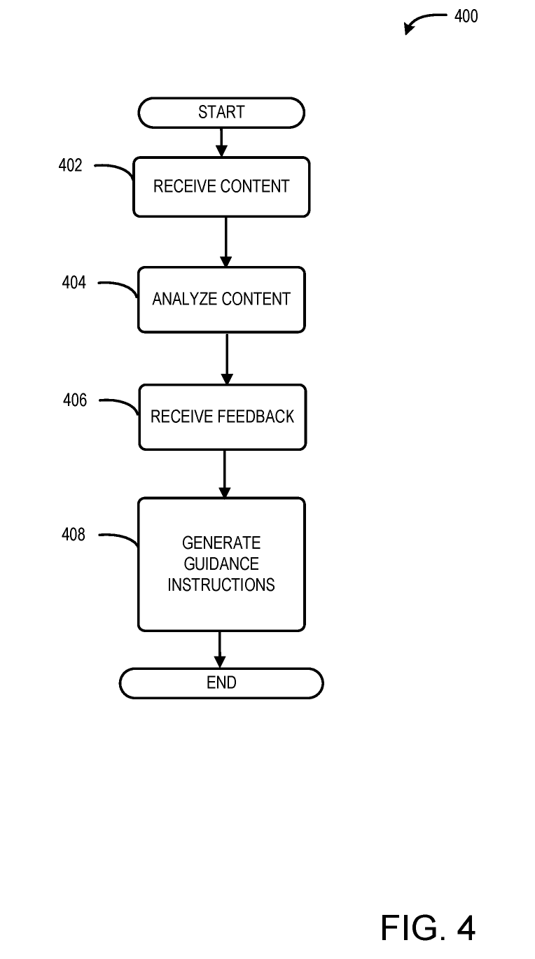

FIG. 4 is a flow diagram showing aspects of a method 400 disclosed herein for providing an artificial intelligence analysis service. It should be understood that the operations of the method 400 are not necessarily presented in any particular order and that performance of some or all of the operations in an alternative order(s) is possible and is contemplated. The operations have been presented in the demonstrated order for ease of description and illustration. Operations can be added, omitted, and/or performed simultaneously, without departing from the scope of the appended claims.

It also should be understood that the illustrated method 400 can be ended at any time and need not be performed in its entirety. Some or all operations of the method 400, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules can be implemented in software, in firmware, in special purpose digital logic, and any combination thereof.

For purposes of illustrating and describing the technologies of the present disclosure, the method 400 disclosed herein is described as being performed by the server computer 104 via execution of computer executable instructions such as, for example, the AI analysis service 108. As explained above, the AI analysis service 108 can include functionality for providing an artificial intelligence analysis service. While the method 400 is described as being provided by the server computer 104, it should be understood that the server computer 104 and/or the nodes 102 can provide the functionality described herein via execution of various application program modules and/or elements. Additionally, devices other than, or in addition to, the server computer 104 can be configured to provide the functionality described herein via execution of computer executable instructions other than, or in addition to, the AI analysis service 108. As such, it should be understood that the described configuration is illustrative, and should not be construed as being limiting in any way.

The method 400 begins at operation 402, where the AI content 113 is received. The AI content 113 can be received from various sources as a result of various operations. For example, the AI content 113 can be received from one or more content providers 110 as a result of an Internet search.

The method 400 continues to operation 404, where the AI content 113 is analyzed. In some examples, the AI analysis service 108 can have access to the AI source list 118. The AI source list 118 can include one or more listings of content providers 110 that are known to be sources of artificial intelligence content. The AI source list 118 can include identifying information such as organizations, a uniform resource locator, internet protocol addresses, and the like.

The AI analysis service 108 can also have access to the AI pattern list 120. The AI pattern list 120 can include one or more patterns that have been determined to be associated with artificial intelligence content. For example, it may have been determined that content having at least 60% of the sentences in “subject-verb-object” format is artificial intelligence content. In other examples, the AI pattern list 120 can include terms or phrases that are known to be used by artificial intelligence sources.

In some examples, the AI pattern list 120 can include previously recorded patterns for sources listed in the AI source list 118. The content analyzer 116 can analyze content provided by a source, retrieve patterns associated with the source stored in the AI pattern list 120, and determine if the pattern of the content match (or are similar to) the patterns associated with the source stored in the AI pattern list 120. If the patterns from the content and the stored patterns do not match, the content analyzer 116 can provide an output indicating that the content does not appear to be content normally output by the source.

The method 400 continues to operation 406, where feedback 126 is received. In some examples, feedback 126 is provided by one or more nodes 102 in communication with the server computer 104. The nodes 102 are connected in a manner that allows a community, i.e. a collection of users or entities, to provide input regarding the AI content 113. In these and other examples, the community can help improve the AI content 113, while also working together to remove and/or correct potentially malicious code.

The method 400 continues to operation 408, where the guidance instructions 122 are generated. The guidance instructions 122 provide information to the content providers 110 relating to the AI content 113 analyzed. As noted above, the guidance instructions 122 may not necessarily be provided only to the content provider 110 that provided the AI content 113. The guidance instructions 122 may be provided to other content providers 110 to allow the other content providers 110 the ability to improve their AI content generation capabilities based on an analysis of AI content generated by a different content provider 110. The method 400 can thereafter end.

The present disclosure also encompasses the subject matter set forth in the following clauses:

Clause 1. A computer-implemented method, the method comprising receiving content generated by a first content provider, analyzing the content to generate a guidance instruction, and providing the guidance instruction to one or more second content providers.

Clause 2. The computer-implemented method of clause 1, further comprising receiving feedback from a node.

Clause 3. The computer-implemented method of any of clauses 1 and 2, further comprising integrating the feedback into the guidance instruction.

Clause 4. The computer-implemented method of any of clauses 1-3, wherein the feedback is received from one or more second nodes.

Clause 5. The computer-implemented method of any of clauses 1-4, wherein the node and the one or more second nodes have different capabilities to provide feedback.

Clause 6. The computer-implemented method of any of clauses 1-5, wherein the feedback comprises information that the content can be used in a malicious manner when received by a destination computer.

Clause 7. The computer-implemented method of any of clauses 1-6, further comprising updating a node knowledge store with the content and the guidance instructions to constantly update a record of information.

Clause 8. The computer-implemented method of any of clauses 1-7, wherein the guidance instruction comprises an identification of the content analyzed and an identification of a portion of the content identified as appearing to be generated by an artificial intelligence source rather than a human.

Clause 9. A computer-readable storage medium having computer-executable instructions stored thereupon that, when executed by a computer, cause the computer to: receive content generated by a first content provider; analyze the content to generate a guidance instruction; and provide the guidance instruction to one or more second content providers.

Clause 10. The computer-readable storage medium of clause 9, further comprising computer-executable instructions to receive feedback from a node.

Clause 11. The computer-readable storage medium of any of clauses 9-10, further comprising computer-executable instructions to integrate the feedback into the guidance instruction.

Clause 12. The computer-readable storage medium of any of clauses 9-11, wherein the feedback is received from one or more second nodes.

Clause 13. The computer-readable storage medium of any of clauses 9-12, wherein the node and the one or more second nodes have different capabilities to provide the feedback.

Clause 14. The computer-readable storage medium of any of clauses 9-13, wherein the feedback comprises information that the content can be used in a malicious manner when received by a destination computer.

Clause 15. The computer-readable storage medium of any of clauses 9-14, further comprising computer-executable instructions to update a node knowledge store with the content and the guidance instructions to constantly update a record of information.

Clause 16. The computer-readable storage medium of any of clauses 9-15, wherein the guidance instruction comprises an identification of the content analyzed and an identification of a portion of the content identified as appearing to be generated by an artificial intelligence source rather than a human.

Clause 17. A system comprising: a processor; and a computer-readable storage medium in communication with the processor, the computer-readable storage medium having computer-executable instructions stored thereupon which, when executed by the processor, cause the processor to receive content generated by a first content provider; analyze the content to generate a guidance instruction; and provide the guidance instruction to one or more second content providers.

Clause 18. The system of clause 17, further comprising computer-executable instructions to: receive feedback from a node; and integrate the feedback into the guidance instruction, wherein the feedback is received from one or more second nodes.

Clause 19. The system of any of clauses 17-18, wherein the node and the one or more second nodes have different capabilities to provide the feedback.

Clause 20. The system of any of clauses 17-19, further comprising computer-executable instructions to update a node knowledge store with the content and the guidance instructions to constantly update a record of information.

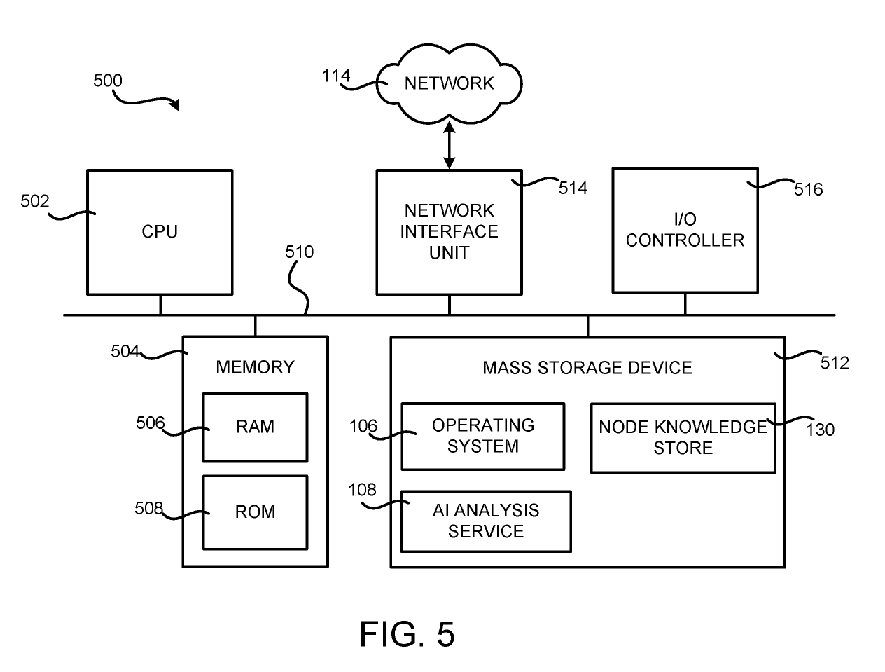

FIG. 5 illustrates an illustrative computer architecture 500 for providing an artificial intelligence analysis service described herein. Thus, the computer architecture 500 illustrated in FIG. 5 illustrates an architecture for a server computer, mobile phone, a smart phone, a desktop computer, a netbook computer, a tablet computer, and/or a laptop computer. The computer architecture 500 can be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 106 and one or more application programs or data stores including, but not limited to, the AI analysis service 108, and the node knowledge store 130.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 500 can operate in a networked environment using logical connections to remote computers through a network, such as the network 114. The computer architecture 500 can connect to the network 114 through a network interface unit 514 connected to the bus 510. It should be appreciated that the network interface unit 514 can also be utilized to connect to other types of networks and remote computer systems. The computer architecture 500 can also include an input/output controller 516 for receiving and processing input from a number of other devices, including a keyboard, mouse, or electronic stylus (not shown in FIG. 5). Similarly, the input/output controller 516 can provide output to a display screen, a printer, or other type of output device (also not shown in FIG. 5).

It should be appreciated that the software components described herein can, when loaded into the CPU 502 and executed, transform the CPU 502 and the overall computer architecture 500 from a general-purpose computing system into a special-purpose computing system customized to facilitate the functionality presented herein. The CPU 502 can be constructed from any number of transistors or other discrete circuit elements, which can individually or collectively assume any number of states. More specifically, the CPU 502 can operate as a finite-state machine, in response to executable instructions contained within the software modules disclosed herein. These computer-executable instructions can transform the CPU 502 by specifying how the CPU 502 transitions between states, thereby transforming the transistors or other discrete hardware elements constituting the CPU 502.

Encoding the software modules presented herein can also transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 can include other types of computing devices, including hand-held computers, embedded computer systems, personal digital assistants, and other types of computing devices known to those skilled in the art. It is also contemplated that the computer architecture 500 might not include all of the components shown in FIG. 5, can include other components that are not explicitly shown in FIG. 5, or might utilize an architecture completely different than that shown in FIG. 5.

Based on the foregoing, it should be appreciated that technologies for providing an artificial intelligence analysis service have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A computer-implemented method, the method comprising:
receiving content generated by a first content provider;
analyzing the content to generate a guidance instruction; and
providing the guidance instruction to one or more second content providers.

2. The computer-implemented method of claim 1, further comprising receiving feedback from a node.

3. The computer-implemented method of claim 2, further comprising integrating the feedback into the guidance instruction.

4. The computer-implemented method of claim 2, wherein the feedback is received from one or more second nodes.

5. The computer-implemented method of claim 4, wherein the node and the one or more second nodes have different capabilities to provide feedback.

6. The computer-implemented method of claim 2, wherein the feedback comprises information that the content can be used in a malicious manner when received by a destination computer.

7. The computer-implemented method of claim 1, further comprising updating a node knowledge store with the content and the guidance instructions to constantly update a record of information.

8. The computer-implemented method of claim 1, wherein the guidance instruction comprises an identification of the content analyzed and an identification of a portion of the content identified as appearing to be generated by an artificial intelligence source rather than a human.

9. A computer-readable storage medium having computer-executable instructions stored thereupon that, when executed by a computer, cause the computer to:
receive content generated by a first content provider;
analyze the content to generate a guidance instruction; and
provide the guidance instruction to one or more second content providers.

10. The computer-readable storage medium of claim 9, further comprising computer-executable instructions to receive feedback from a node.

11. The computer-readable storage medium of claim 10, further comprising computer-executable instructions to integrate the feedback into the guidance instruction.

12. The computer-readable storage medium of claim 10, wherein the feedback is received from one or more second nodes.

13. The computer-readable storage medium of claim 12, wherein the node and the one or more second nodes have different capabilities to provide the feedback.

14. The computer-readable storage medium of claim 10, wherein the feedback comprises information that the content can be used in a malicious manner when received by a destination computer.

15. The computer-readable storage medium of claim 9, further comprising computer-executable instructions to update a node knowledge store with the content and the guidance instructions to constantly update a record of information.

16. The computer-readable storage medium of claim 9, wherein the guidance instruction comprises an identification of the content analyzed and an identification of a portion of the content identified as appearing to be generated by an artificial intelligence source rather than a human.

17. A system comprising:
a processor; and
a computer-readable storage medium in communication with the processor, the computer-readable storage medium having computer-executable instructions stored thereupon which, when executed by the processor, cause the processor to
receive content generated by a first content provider;
analyze the content to generate a guidance instruction; and
provide the guidance instruction to one or more second content providers.

18. The system of claim 17, further comprising computer-executable instructions to:
receive feedback from a node;
integrate the feedback into the guidance instruction, wherein the feedback is received from one or more second nodes.

19. The system of claim 18, wherein the node and the one or more second nodes have different capabilities to provide the feedback.

20. The system of claim 17, further comprising computer-executable instructions to update a node knowledge store with the content and the guidance instructions to constantly update a record of information.
